(19) United States
(12) Patent Application Publication
(10) Pub. No.: US 2022/0385652 A1
(43) Pub. Date: Dec. 1, 2022

(54) METHOD AND SYSTEM FOR VERIFYING THE ELIGIBILITY OF A USER BASED ON LOCATION

(71) Applicant: OCTOPUS SYSTEMS LTD., Bnei Brak (IL)

(72) Inventors: Tal BAR OR, Kfar Sirkin (IL); Baruch TAGORI, Ramat Gan (IL)

(21) Appl. No.: 17/824,159

(22) Filed: May 25, 2022

(30) Foreign Application Priority Data
Jun. 1, 2021 (IL) 283610

(51) Int. Cl. H04L 9/40

(52) U.S. Cl. CPC H04L 63/0853; H04L 63/102; H04L 63/0884

(57) ABSTRACT

A method and system for carrying out a security processes between a client and a relying party. in more particular, to location-based security processes

### FIELD OF THE INVENTION

The invention relates in general to a method and system for carrying out a security processes between a client and a relying party. in more particular, to location-based security processes.

### BACKGROUND

The present invention relates to a method for carrying out a security process between a user and a relying party. A user is, for example, a person operating an computerized service device, for the purpose of receiving information, conduct transactions, or utilize any digital service provided between a service provider (e.g., a bank) and a client of this service provider.

As of today, services are provided by the service provider over the internet, via machine such ATM's, parking payment machines, and more. In multiple cases these services involve transactions, payments and money drawing. Hence the requirement to provide secure services is a must, for protecting the payments and the money of the customers.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment a system comprising at least one hardware processor and a non-transitory computer-readable storage medium having stored thereon program instructions, the program instructions executable by the at least one hardware processor to: Receive a user information authenticated and an authentication timestamp from a relaying party; identify the relaying party location; receive a user location sent to the system by a mobile computerized device operated by the user and location sending timestamp; determine that the user is eligible to perform at least one operation in the relaying party in case:
a. a proximity between said relaying party location and said user location is identified,
b. there is a time match between said location sending timestamp and said authentication timestamp.

A method operable on a system comprising at least one hardware processor and a non-transitory computer-readable storage medium having stored thereon program instructions, the program instructions executable by the at least one hardware processor, the method comprising:

receiving user information authenticated and an authentication timestamp from a relaying party; identifying the relaying party location; receiving a user location sent to the system by a mobile computerized device operated by the user and location sending timestamp; determining that the user is eligible to perform at least one operation in the relaying party in case:
a. proximity between said relaying party location and said user location is identified,
b. there is a time match between said location sending timestamp and said authentication timestamp.

In some embodiments, wherein the proximity is identified in case the distance between said relaying party location and said user location is no longer than a distance threshold.

In some embodiments, wherein the instructions comprises instructions to define a first geo-fence for the relaying party location and a second geo-fence for the computerized device location, and to identify the proximity on the basis of overlap of at least a part of said geo-fences.

In some embodiments, wherein the time match is determined in case a difference between said location sending timestamp and said authentication timestamp is no longer than a time-threshold.

In some embodiments, the present disclosure provides for defining a first geo-fence for the relaying party location and a second geo-fence for the computerized device location, and to identify the proximity on the basis of overlap of at least parts of said geo-fences.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a method for determining the eligibility of a user, according to exemplary embodiments of the present disclosure;

FIG. 2 shows a method for determining the eligibility of a user in conjunction with a relaying party, according to exemplary embodiments of the present disclosure, and

FIG. 3 shows a block diagram of an exemplary system according to an embodiment of the present disclosure.

### DETAILED DESCRIPTION

Disclosed herein a computerized system and method operable thereon designed to verify whether a user as eligible to perform operations on at least one other relying party, based, at least in part, on authenticated user-information and the real-time-location of the user.

In some embodiments, the present disclosure provides for identifying whether a user is eligible to perform one or more operations on at least one relaying party such as relaying computerized system.

Accordingly, in some embodiments, the present disclosure can be combined, integrated, and/or interoperated with a relaying party, e.g., an automated teller machine (ATM), designed to be operated by one or more users. In some embodiments, such a relaying party is a relaying computerized system utilized by users for receiving information, sending information, receiving or depositing money, perform financial transactions, such as cash withdrawals, deposits, funds transfers, or account information inquiries. In some embodiments, such relaying party employs an authentication mechanism designed to authenticate the user for the purpose of validating the user prior allowing the user to preform one or more operations enabled by the relaying party.

Further, in some embodiments, the present disclosure provides for verifying the eligibility of the user operating the relaying party or any of the components thereof, based on real-time-location. In some embodiments, the system can operate in conjunction with the authentication mechanism of the relaying party. Thus, in some embodiments, a relaying party can operate an authentication mechanism, and then, upon a successful authentication process, the eligibility verification process of the user, based on real-time-location can take place. In some embodiments, based on successful eligibility process, the user can perform one or more operations on the relaying party.

As used herein the term real-time-location refer to the location of the user operating the relaying party or any of the components thereof. For example, in case the user operating a relaying party such a computerized system, the location of the user while operating the relaying party is the real-time-location of the user.

In some embodiments, the present disclosure provides for conducting an eligibility verification process based on receiving a location of a user requesting to perform operations the relaying party, identifying relaying party location and, in real-time, determine whether there is a proximity between the relaying party location and the user location. Thus, in some embodiments, in case there is a proximity between the locations of the relaying party and the user, the user is eligible to perform at least one operation on the relaying party.

In some embodiments, the user location is sent by the user to the system. In some embodiments, such a location sending can be accomplished by utilizing a computerized device, e.g., a mobile telephone device operated by the user.

As used herein, the term real-time refers to events occurring at the same time. Thus, real-time is defined by a time threshold. For example, in case the difference between the occurrence time of the system location identification and the occurrence time of the location sending by the user, is no longer than a predefined time threshold, the two events occurred in real-time.

As used herein the term relaying party location refer to a location of at least one component of the relaying party. In some embodiments, such a relaying party comprises multiple components, wherein at least one of the components thereof is a computerized device with a user interface allowing a user, e.g., a customer, to communicate and perform operations on said computerized device. For example, the relaying party location can be the ATM operated and used by the user.

In some embodiments, the present disclosure provides for verifying the eligibility of the user to operate the relaying party, based on a request from the user and geographical locations of the user and the relaying party, or one of the components thereof. In some embodiments, timestamps are utilized to verify that the relaying party, or at least one of the components thereof, and the user requesting to operate the relaying party are at the same location in real-time. For example, in some embodiments, the system can validate that the occurrence of the request to operate the relaying party received from the user, and occurrence of sending the user location are two events occurred in real-time.

Exemplary embodiments employ variety of approaches for validating the identity of the user, identifying the locations of a user independently of the relaying party, compare between the user locations and the relaying party location, and based at least on part of the comparison, determine if there is a proximity between the relaying party location and the user location.

In some embodiments, the user location is received from a computerized device such as mobile telephone device, a mobile computer such as a laptop device, a personal computer, a personal computer tablet, or any mobile device designed to identify the location thereof and then send over telecommunication network.

In some embodiments, the user location is sent on the internet and/or via a cellular communication used by mobile telephone. In some embodiments, any utilization of communication such as wired communication, or wireless communication is used for sending the user location. In some embodiments, the user location can be sent over network for data communication designed to convey, command, direct, or regulate the behavior of other devices or systems.

In addition to the exemplary aspects and embodiments described above, further aspects and embodiments will become apparent by reference to the figures and by study of the following detailed description.

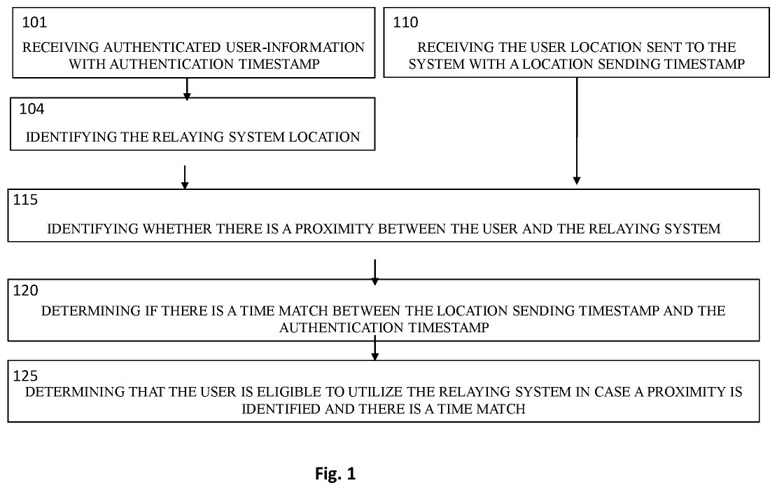

Reference is made to FIG. 1 showing a method for determining the eligibility of a user, according to exemplary embodiments of the present disclosure. Step 101 shows the part when the system receives user-authentication information of an authenticated user. In some embodiments, the user information is received by a relaying party. In some embodiments, the relaying party authenticates the user, and based upon a successful authentication, the user is validated and the information thereof is sent to the system.

In some embodiments, the user-authentication information comprises a secret, user personal details, a PIN (personal Identification Number), or any other details utilized for the authentication process. In some embodiments, the user-authentication information comprises just an approval that the user is authenticated. In some embodiments, the user-authentication information comprises identification details which can be utilize to receive details about the user. In some embodiments, such details can comprise any ID to identify the user in the system, or in the relaying party. In some embodiments, additional details can be in the user-authentication information. For example, user telephone number can be added to the received user-authentication information.

In some embodiments, a timestamp, defined herein as authentication timestamp, is associated with the user-authentication information. In some embodiments, the authentication timestamp can be any timestamp the relaying party associated with the user-authentication information. In some embodiments, the authentication timestamp can be the time the user requested to operate the relaying party or any of the components thereof. In some embodiments, the authentication timestamp can be the time of the authentication process. For example, the time the user sent the authentication request, or the time the user authentication is ended successfully.

In some embodiments, details regarding the relaying party are also added to the user-authentication information, for example a code identifying the relaying party location, on which relaying party the user authenticated. In some embodiments, the specific location of the relaying party may be associated with the user-authentication information. In some embodiments, the location is a string of charts representing a name. Exemplary embodiments of the present disclosure utilize variety of techniques to identify or represent the location. In some embodiments, such techniques can be any type of mapping technology allowing a t computerized system to associate data to geographic points on a geographic map. In some embodiments, the location can represent an area surrounding a specific point of presence in the map.

In step 104 the system identifies the relaying party location. In some embodiments, identification of the relaying party location may be in the system, e.g., according to code associated with the user-authentication information.

In step 110 the location of a user is received by the system. In some embodiments, the user location is associated with a location sending timestamp. In some embodiments, the location sending timestamp is generated and associated with the user location, by a mobile computerized device operated by the user.

In some embodiments, upon a user-authentication information, the system sends a request to the user to send back the location. For example, the system may utilize a telephone number of a user (e.g., a smart mobile telephone) to send a request for sending back the location of the user. In some embodiments, the user may operate an application, such as software instructions operated by the mobile telephone, to discover the location.

In some embodiments, the telephone utilizes a diversity of computer instructions, or application for the purpose of identifying the geographical location of the telephone, or the computerized device utilized for sending the location. In some embodiments, the geographical location of the telephone is defined to be the geographical location of the user.

In some embodiments, additional authentication process may take place between the system and the mobile telephone, or the computerized device, to validate the user operating the mobile telephone, or the computerized device.

In step 115 the system identifies whether there is a proximity between the user location received in step 110 and the relaying party location received in step 101.

In some embodiments, the process of identifying whether there is a proximity is performed by a distance threshold. Hence, in some embodiments, if the distance between the user location and the relaying party location is shorter from the distance threshold, a proximity is identified.

In some embodiments, the system may generate a geo-fence surrounding the locations, such as a first geo-fence surrounding the relaying party location and a second geo-fence surrounding the computerized device location. In some embodiments, identifying a proximity on the basis of overlap of at least parts of the first geo-fence and the second geo-fence.

In step 120 the system determines if there is a match between the times. In some embodiments, such a match between the location sending timestamp and the authentication timestamp. In some embodiments, the time match is determined in case the difference between the between the location sending timestamp and the authentication timestamp is shorter than a predefined time length.

In step 125 the system determines that the user is eligible to utilize and/or operate the relaying party, or at least part of the services thereof, in case: 1) a proximity is identified in step 115, and 2) a time match is determined in step 120.

In some embodiments, a message or a code may be sent to the relaying party identifying that the user is eligible as aforementioned. In some embodiments, the relaying party may utilize the message and/or the code for allowing the user to perform the operation to which the user is eligible.

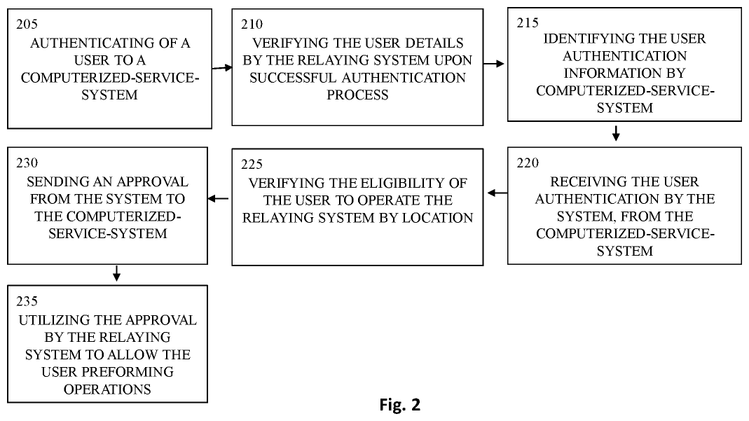

Reference is made to FIG. 2 showing a method for determining the eligibility of a user in conjunction with a relaying party, according to exemplary embodiments of the present disclosure. In FIG. 2 step 205 is an authentication process between a user requiring to perform operations on a relaying party.

In some embodiments, the authentication process is performed by the relaying party, independently of the system conducting the method for determining the eligibility of a user.

In some embodiments, the relaying party is a computerized system enables to perform diverse financial transactions for users. In some embodiments, the relaying party an automated teller machine (ATM). In some embodiments, the relaying party is provided and held by a bank or any financial institute for the purpose of serving the customer thereof.

In some embodiments, the authentication process conducted by the relaying party involves using a payment card issued to users for performing one or more financial operations, e.g., a credit card.

In some embodiments, in step 205 a personal ID number (PIN) is provided by the user as a part of the authentication process. In some embodiments, upon a successful authentication process the relaying party, or any of the components thereof, issues a user-authentication information comprising one or more of the following: Branch Number, ATM identification number, authentication timestamp, user details. In some embodiments, additional details may be issued by the relaying party or any of the components thereof.

In step 215 the relaying party verifies that the details in the user-authentication information provided and issued at the authentication process are correct and valid. In some embodiments, the process conducted in step 215 ends up where additional details are added to the user-authentication information.

In some embodiments, the relaying party sends a request for the user to send back the user location. In some embodiments, the request is based on the user-information details, e.g., telephone number of the mobile telephone device held by the user.

In some embodiments, the request may be sent by the system designed to verify the eligibility of the user to perform operations on the relaying party. Hence, in some embodiments, the system designed to verify the eligibility of the user disclosed herein and the relaying party are two independent and standalone systems configured and designed to interoperate with each other. In some embodiments, the system designed to verify the eligibility of the user to perform operations on the relaying party is an auxiliary system of the relaying party utilized for the purposes of reinforcing the security processes such as the authentication and/or authorization processes.

In step 220 the system designed to verify the eligibility of the user receives the location of the user. In some embodiments, a user can send the location by using a computerized device capable of receiving and sending messages. In some embodiments, the location sent to the system is associated with a location sending timestamp.

In some embodiments, the location sending timestamp may be issued by the computerized device, e.g., the mobile telephone device of the user. In some embodiments, the location sending timestamp is a timestamp issued by the system, upon receiving the location from the user.

In step 225 the system conducts a process to determine the eligibility of the user to perform operations on the relaying party. In some embodiments, the system can identify whether the user and the relaying party are in proximity one to each other. In some embodiments, a proximity is defined by a distance which is no longer than a distance threshold.

In some embodiments, the system conducts diverse operation and method from the field of location-based services, where geographic data and information are utilized for identifying distances, identifying location, and establishing virtual permitters to calculate distances and areas.

The system may also compare the received timestamps as part of the process described in step 225. Thus, the system can determine the time match, wherein there is a time match in case a difference between the location sending timestamp and the authentication timestamp is no longer than a time-threshold.

In step 230, upon successful eligibility process, namely the proximity identification process and the timestamp comparison are complete successfully, the system issues an approval. In some embodiments, the approval can be sent to the relaying party. In some embodiments, such an approval can be used by the relaying party to approve one or more operations conducted by the user on the relaying party. In some embodiments, the approval can be a code, a number, a certificate, a file, or the like. In some embodiments, the approval is a digital means which be transferred from one computerized system to another.

In step 235 the relaying party utilizes the approval to approve at least some of the operations conducted and/or requested by the users. For example, the user may be allowed to withdraw money from an ATM.

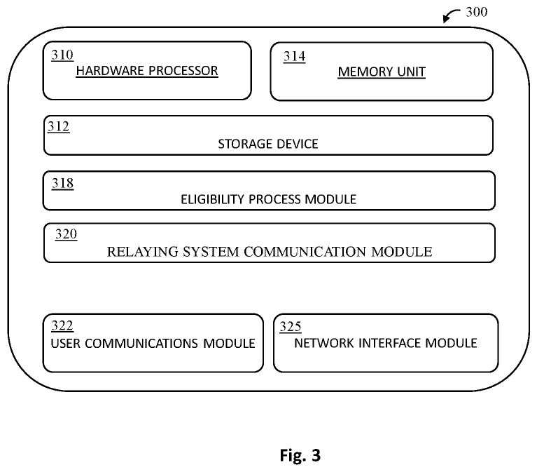

Reference is made to FIG. 3 showing a block diagram of an exemplary system 300 according to an embodiment of the present disclosure. System 300 as described herein is only an exemplary embodiment of the present invention, and in practice may have more or fewer components than shown, may combine two or more of the components, or a may have a different configuration or arrangement of the components. The various components of system 300 may be implemented in hardware, software or a combination of both hardware and software. In various embodiments, system 300 may comprise a dedicated hardware device, or may form an addition to/or extension of an existing device.

System 300 may store in storage device 312 software instructions or components configured to operate a hardware processor 310 comprising such as hardware processor (also “hardware processor,” “CPU,” or simply “processor). In some embodiments, the software components may include an operating system, including various software components and/or drivers for controlling and managing general system tasks (e.g., memory management, storage device control, power management, etc.) and facilitating communication between various hardware and software components.

In some embodiments, the software components of the system 300 may comprise an operating system, including various software components and/or drivers for controlling and managing general system tasks (e.g., memory management, storage system control, power management, etc.) and facilitating communication between various hardware and software components.

In some embodiments, system 300 may comprise a hardware processor 305, a user communications module 322, memory unit 314, a network interface module 325, a storage device 312, a relaying party communication module 320, and eligibility process module 318.

In some embodiments, the eligibility process module 318 is configured to conduct the process for determining the eligibility of an authenticated user to preform operation on the relaying party. In some embodiments, the eligibility process module 318 is configured to identify the proximity of the user location and the relaying party location.

In some embodiments, the eligibility process module 318 is configured to determine if there is a time match between the location sending timestamp and the authentication timestamp.

In some embodiments, the eligibility process module 318 is configured to administrate the entire process of receiving locations and timestamp, and determine whether the user is eligible to perform one or more operations on the relaying party.

In some embodiments, the relaying party communication module 320 is configured to communicate with the relaying party, receive information such as user-authentication information, receive additional details, edit the user-authentication information and the like.

In some embodiments, the relaying party communication module 320 is also configured to issue an approval and send it to the relaying party. For example, in some embodiments, where the relaying party is an ATM, the relaying party communication module 320 can issue a code and send to the ATM for approving a withdraw of money by the user.

In some embodiments, the user communication module 322 is configured to communicate with the user, e.g., via sending message to the mobile telephone operated by the user. In some embodiments, the user communication module 322 is configured to receive the location of the user, to request the location from the user, to identify the timestamp associated with the location. In some embodiments, the user communication module 322 is configured to issue the timestamp associated with the location, upon receiving the location from the user.

In some embodiments, the network interface module 325 is configured to communicate over telecommunicating network, such as internet network, cellular network and the like.

Aspects of the present invention are described herein with reference to flowchart illustrations and/or block diagrams of methods, apparatus (systems) and computer program products according to embodiments of the invention. It may be understood that each block of the flowchart illustrations and/or block diagrams, and combinations of blocks in the flowchart illustrations and/or block diagrams, can be implemented by computer program instructions. These computer program instructions may be provided to a hardware processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other systems to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other systems to cause a series of operational steps to be performed on the computer, other programmable apparatus or other systems to produce a computer implemented method such that the instructions which execute on the computer or other programmable apparatus provide methods for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It may also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations may be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

What is claimed is:

1. A system comprising at least one hardware processor and a non-transitory computer-readable storage medium having stored thereon program instructions, the program instructions executable by the at least one hardware processor to:
receive a user information authenticated and an authentication timestamp from a relaying party;
identify the relaying party location;
receive a user location sent to the system by a mobile computerized device operated by the user and location sending timestamp;
determine that the user is eligible to perform at least one operation in the relaying party in case:
a. a proximity between said relaying party location and said user location is identified,
b. there is a time match between said location sending timestamp and said authentication timestamp.

2. The system of claim 1, wherein the proximity is identified in case the distance between said relaying party location and said user location is no longer than a distance threshold.

3. The system of claim 1, wherein said instructions comprises instructions to define a first geo-fence for the relaying party location and a second geo-fence for the computerized device location, and to identify the proximity on the basis of overlap of at least a part of said geo-fences.

4. The system of claim 1, wherein the time match is determined in case a difference between said location sending timestamp and said authentication timestamp is no longer than a time-threshold.

5. A method operable on a system comprising at least one hardware processor and a non-transitory computer-readable storage medium having stored thereon program instructions, the program instructions executable by the at least one hardware processor, the method comprising:
receiving user information authenticated and an authentication timestamp from a relaying party;
identifying the relaying party location;
receiving a user location sent to the system by a mobile computerized device operated by the user and location sending timestamp;
determining that the user is eligible to perform at least one operation in the relaying party in case:
a. a proximity between said relaying party location and said user location is identified,
b. there is a time match between said location sending timestamp and said authentication timestamp.

6. The method of claim 5, wherein the proximity is identified in case the distance between said relaying party location and said user location is no longer than a distance threshold.

7. The method of claim 5, further defining a first geo-fence for the relaying party location and a second geo-fence for the computerized device location, and to identify the proximity on the basis of overlap of at least parts of said geo-fences.

8. The method of claim 5, wherein the time match is determined in case a difference between said location sending timestamp and said authentication timestamp is no longer than a time-threshold.
